(19) United States
(12) Patent Application Publication
(10) Pub. No.: US 2026/0169244 A1
(43) Pub. Date: Jun. 18, 2026

(54) INTERMITTENTLY BONDED OPTICAL FIBER RIBBON HAVING VARIABLE BOND SPACING

(71) Applicant: CORNING RESEARCH & DEVELOPMENT CORPORATION, Corning, NY (US)

(72) Inventors: Ronald Steven Black, Hickory, NC (US); Mark Hanson Bushnell, Hickory, NC (US)

(21) Appl. No.: 19/536,513

(22) Filed: Feb. 11, 2026

Related U.S. Application Data
(63) Continuation of application No. PCT/US2024/043318, filed on Aug. 22, 2024.
(60) Provisional application No. 63/534,006, filed on Aug. 22, 2023.

(51) Int. Cl. G02B 6/44

(52) U.S. Cl. CPC G02B 6/4403; G02B 6/443; G02B 6/44384; G02B 6/448

(57) ABSTRACT

A flexible optical fiber ribbon that is configured to mitigate the effects of multipath interference includes a first optical fiber and a second optical fiber. The first and second optical fibers are intermittently joined by a plurality of bonds that include a first bond, a second bond, and a third bond, wherein the first, second, and third bonds are sequential bonds along the lengths of the first and second optical fibers. The first bond and the second bond are separated by a first distance, whereas the second bond and the third bond are separated by a second distance that is different than the first distance.

### RELATED APPLICATIONS

This application is a continuation of International Patent Application No. PCT/US2024/043318, filed on Aug. 22, 2024, which claims priority to U.S. Provisional Patent Application No. 63/534,006 filed on Aug. 22, 2023, and entitled “INTERMITTENTLY BONDED OPTICAL FIBER RIBBON HAVING VARIABLE BOND SPACING,” the entirety of which is incorporated herein by reference.

### BACKGROUND

Optical fiber ribbons are employed in optical fiber cables to facilitate organization of optical fibers, thereby making it easier for an installer of an optical fiber cable to make connections between the optical fibers in an optical fiber cable and other nodes in a network. Conventionally, optical fiber ribbons have had a rigid, planar configuration to ensure organization of the optical fibers.

More recently, flexible optical fiber ribbons have been developed. These flexible optical fiber ribbons typically employ a series of intermittent bonds between optical fibers along the length of the ribbon, which allow the ribbon to roll, fold, or otherwise flex to take lower-stress positions within an optical fiber cable, allowing for higher packing densities.

### SUMMARY OF THE DISCLOSURE

The following is a brief summary of subject matter that is described in greater detail herein. This summary is not intended to be limiting as to the scope of the claims.

During spectral testing oscillations in attenuation across the spectrum were observed in flexible optical fiber ribbons that employ intermittent bonds between optical fibers (or groups of optical fibers). Applicants theorized that this was the result of multipath interference (MPI). Intermittent bonds between optical fibers can introduce microbends that cause power to be lost from the fundamental mode of an optical fiber to higher-order modes (HOMs). Light propagating in these HOMs within the optical fiber experiences a different effective index of refraction (EIOR) than light propagating in the fundamental mode. Thus, the HOMs exhibit a propagation delay relative to light in the fundamental mode. When light propagating in the HOMs reaches a next bond along the length of the optical fiber, some portion of the power in the HOMs returns to the fundamental mode. The result is MPI that can cause power penalties in the end user's system.

A flexible, intermittently-bonded optical fiber ribbon is disclosed herein that is configured to mitigate the effects of MPI. An exemplary optical fiber ribbon comprises a plurality of optical fibers that includes a first optical fiber and a second optical fiber. The first optical fiber and the second optical fiber are intermittently bonded together along their respective lengths by a first set of bonds. The first set of bonds have a variable spacing. By way of further example, the first set of bonds includes a first bond, a second bond that is a next bond in sequence from the first bond along the length of the ribbon, and a third bond that is a next bond in sequence from the second bond along the length of the ribbon. The first bond and the second bond in the first set of bonds are separated by a first spacing. The second bond and the third bond are separated by a second spacing that is greater than or less than the first spacing.

By employing a variable bond spacing instead of a fixed bond spacing in the optical fiber ribbon, the effects of HOM light returning to the fundamental mode within the optical fibers of the optical fiber ribbon is reduced. As will be explained in greater detail below, the period of an interference pattern resulting from a pair of such intermittent bonds is in part a function of the distance between such bonds along the length of the ribbon. Therefore, when the distance between bonds along the length of an optical fiber ribbon is variable, a plurality of different MPI patterns with different periods results. These MPI interference patterns interfere with one another, reducing the amplitude of the oscillations in attenuation across the spectrum of a signal transmitted through the ribbon, as compared to a flexible, intermittently-bonded ribbon having fixed bond spacing.

The above summary presents a simplified summary in order to provide a basic understanding of some aspects of the systems and/or methods discussed herein. This summary is not an extensive overview of the systems and/or methods discussed herein. It is not intended to identify key or critical elements or to delineate the scope of such systems and/or methods. Its sole purpose is to present some concepts in a simplified form as a prelude to the more detailed description that is presented later.

### BRIEF DESCRIPTION OF THE DRAWINGS

The accompanying drawings are included to provide a further understanding, and are incorporated in and constitute a part of this specification. The drawings illustrate one or more embodiments, and together with the description serve to explain principles and operation of the various embodiments.

FIG. 1 is a perspective view of an exemplary optical fiber ribbon;

FIG. 2 is a schematic diagram of a generalized intermittent bonding pattern for an optical fiber ribbon.

FIG. 3 is a schematic diagram of an exemplary intermittent bonding pattern for an optical fiber ribbon having a variable bond spacing.

FIG. 4 is a schematic diagram of another exemplary intermittent bonding pattern for an optical fiber ribbon having a variable bond spacing.

FIG. 5 is a cross-sectional view of an exemplary optical fiber cable that incorporates optical fiber ribbons having a variable bond spacing.

FIG. 6 is a flow diagram that illustrates an exemplary methodology for forming an intermittently-bonded optical fiber ribbon having a variable spacing between bonds that join a same pair of subunits.

### DETAILED DESCRIPTION

Various technologies pertaining to an intermittently-bonded optical fiber ribbon and optical fiber cables relating thereto are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices may be shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something, and is not intended to indicate a preference.

As used herein, the term “about” when modifying a measure means within +0.5% of such measure. That is, the phrase “X is about 10 millimeters” means X lies in a range of 9.95 mm to 10.05 mm, inclusive.

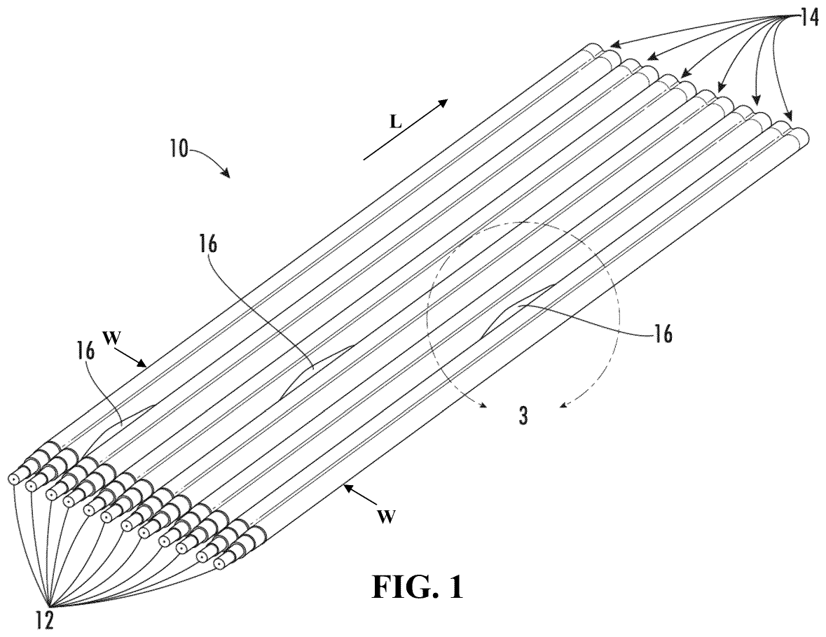

Referring now to FIG. 1, an embodiment of an optical fiber ribbon 10 according to the present disclosure is depicted. The optical fiber ribbon 10 includes a plurality of optical fibers 12. In one or more embodiments, including the embodiment depicted, the optical fiber ribbon 10 includes twelve optical fibers 12. In one or more embodiments, the number of optical fibers 12 contained in the optical fiber ribbon 10 varies from, e.g., four to thirty-six. In certain embodiments, the optical fibers 12 are grouped into subunits 14 having one or more optical fibers 12. In one or more embodiments, such as the embodiment shown in FIG. 1, the subunits 14 each include two optical fibers 12. Thus, for example, in the embodiment of FIG. 1, the optical fibers 12 are arranged into six subunits 14. The optical fibers 12 of each subunit 14 are bonded to each other along the length L of the optical fiber ribbon 10, but the subunits 14 are only intermittently bonded along the length of the optical fiber ribbon 10.

FIG. 1 depicts intermittent bonds 16 staggered along the length of the subunits 14. The intermittent bonds 16 between two adjacent subunits 14 may be spaced apart by, e.g., 15 mm to 200 mm. In one or more embodiments, the intermittent bonds 16 are applied in a “wet-on-wet” application process, which creates diffusion of the material of the intermittent bond 16 with a coating material of the subunits 14. However, it is to be understood that any of various approaches to applying the bonds 16 may be employed. In embodiments, the optical fiber ribbon 10 has a first configuration in which the optical fibers 12 are arranged in a substantially planar row, which helps to organize the optical fibers 12 for mass fusion splicing. Further, as will be described more fully below, the subunits 14 also can be rolled, folded, curled, or bundled into a non-planar configuration (e.g., a circle or spiral) for space-saving packaging in an optical fiber cable, especially optical fiber cables having a circular cross-section. The optical fibers 12 of the optical fiber ribbon 10 are able to transition from the first configuration to the second configuration because the subunits 14 are only held together intermittently along the length of the optical fiber 10 by the intermittent bonds 16.

In a conventional optical fiber ribbon, each optical fiber is bonded to its neighboring optical fiber(s) along the entire length of the optical fiber ribbon to hold them in the planar configuration. According to one or more embodiments of the present disclosure, however, the fiber subunits 14 are bonded intermittently along the length of the optical fiber ribbon 10 so that the optical fibers 12 are not rigidly held in the planar configuration. In between the intermittent bonds 16, the subunits 14 are not bonded to each other along their length. In this way, the present optical fiber ribbon 10 provides the advantages of a ribbon with respect to fiber organization and mass fusion splicing while also allowing the optical fiber ribbon 10 to curl, roll, fold, or bundle across the width W of the ribbon allowing for a more compact cable design.

In order to provide a compact ribbon design, the intermittent bonds 16 can be applied between the subunits 14 in such a manner that the intermittent bonds 16 do not overlap across the width of the optical fiber ribbon 10. That is, the optical fiber ribbon 10 can be configured such that no two intermittent bonds 16 have the same longitudinal position on the optical fiber ribbon 10. Put differently, the optical fiber ribbon 10 may be configured such that each intermittent bond 16 has a unique longitudinal position on the optical fiber ribbon 10 that is not shared by any other intermittent bond 106 along the length of the optical fiber ribbon 10. If the intermittent bonds 16 were to overlap, the material of the bonds 16 would concentrate at locations along the length of the ribbon 10 and thus result in an increase in the rigidity of the optical fiber ribbon 10 across the width at these discrete locations, decreasing the ability of the optical fiber ribbon 10 to curl, fold, or bundle. However, it is to be appreciated that locations of the bonds 16 are not limited to unique longitudinal positions, and in some embodiments overlap of positions of the intermittent bonds 16 is tolerated.

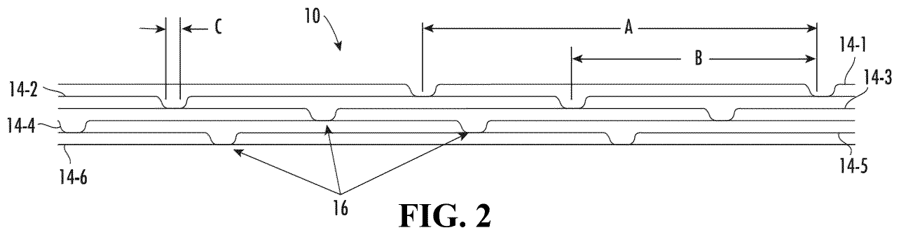

FIG. 2 depicts a schematic representation of a generalized intermittent bonding pattern for the optical fiber ribbon 10. In the depiction of FIG. 2, the horizontal lines represent subunits 14 of one or more optical fibers 12 (e.g., two optical fibers 12 as shown in FIG. 1), and individual subunits are referenced as 14-1, 14-2, . . . 14-n. In the embodiment shown in FIG. 2A, there are six subunits 14-1, 14-2, 14-3, 14-4, 14-5, 14-6. The regions where one subunit 14 dips to contact an adjacent subunit 14 represent intermittent bonds 16 between the subunits 14. It should be noted that the dips depicted in FIG. 2 are used to illustrate the intermittent bonds 16 and do not indicate that the subunits 14 would actually physically dip at the locations of intermittent bonds 16. In order to describe the intermittent bonding pattern in embodiments, three parameters are utilized. The first parameter “A” refers to the longitudinal distance between sequential intermittent bonds 16 joining a particular pair of subunits 14 (e.g., the longitudinal distance between an adjacent pair of intermittent bonds 16 joining subunit 14-1 and subunit 14-2). The second parameter “B” refers to the longitudinal offset between the intermittent bonds 16 of adjacent pairs of subunits 14. Thus, for example, second parameter B refers to the offset between the intermittent bond 16 of the subunit pair 14-1, 14-2 and the intermittent bond 16 of the subunit pair 14-2, 14-3. The third parameter “C” refers to the length of each intermittent bond 16.

Oscillations in attenuation across the spectrum in signals transmitted through an optical fiber ribbon configured similarly to the optical fiber ribbon 10 described above has been observed by Applicant under certain operating conditions. As indicated above, Applicant has theorized that this oscillation is due to MPI caused by the bonds' 16 transferring some of the power of such signals into HOMs that exhibit different EIOR than the fundamental mode.

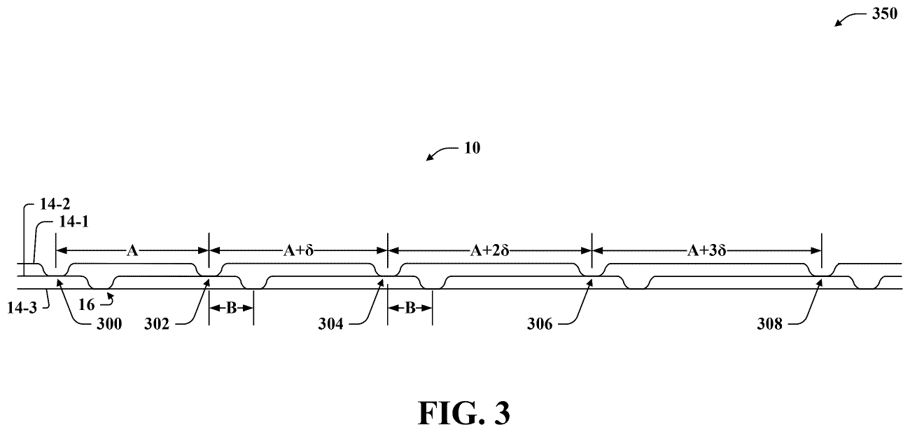

Referring now to FIG. 3, a schematic diagram 350 of an intermittent bonding pattern for the optical fiber ribbon 10 that is configured to mitigate the effects of MPI is illustrated. The schematic diagram 350 depicts a subset of the subunits 14, namely, subunits 14-1, 14-2, and 14-3, however it is to be understood that the principles set forth with respect to FIG. 3 are applicable to an optical fiber ribbon having substantially any number of subunits and/or fibers.

In the MPI-mitigating intermittent bonding pattern depicted in FIG. 3, the bonds 16 between a pair of subunits 14 have a variable spacing. For example, subunits 14-1 and 14-2 are joined by a plurality of sequential bonds 300-308. As used herein, sequential bonds refer to bonds between a same pair of subunits 14 that occur in order along the length of the optical fiber ribbon 10. Adjacent bonds refer to bonds between a same pair of subunits 14 that are next in order to one another along the length of the optical fiber ribbon 10. Thus, by way of example, bonds 300-308 are sequential, whereas bonds 300 and 302, 302 and 304, 304 and 306, and 306 and 308 are pairs of adjacent bonds.

In various embodiments, sequential bonds 300-308 between the subunits 14-1 and 14-2 are characterized by a variable spacing having a base spacing value offset by a step increase and/or decrease. For example, as shown in FIG. 3, adjacent bonds 300, 302 can have a spacing A. The next-in-sequence set of adjacent bonds 302, 304 has a spacing A+δ where δ is a step offset value. Similarly, next-in-sequence set of adjacent bonds 304, 306 has a spacing A+2δ. Then, next-in-sequence set of adjacent bonds 306, 308 has a spacing A+3δ. In general, a base-spacing-with-offset variability of the bond spacing can be characterized by the formula A+nδ where A is the base spacing value and n is an integer. In an exemplary embodiment, the variable spacing of sequential bonds has a base spacing value of about 70 mm, and a step increase/decrease of 0.5 mm. In a more particular embodiment, the spacing of sequential bonds varies between about 67 mm and about 73 mm with a base spacing of 70 mm. However, it is to be appreciated that substantially any number of step increase/decreases can be employed.

A pattern of the step increase/decrease employed to modulate the variable spacing of sequential bonds 300-308 can be any of various patterns. In various embodiments, the step increase/decrease can be modulated according to a sawtooth pattern. For example, the spacing of the sequential bonds 300-308 can be monotonically increasing in uniform steps from a lowest value to a highest value until the highest value is reached, and then the spacing can reset to the lowest value, beginning another spacing cycle. In other embodiments, the step-increase/decrease can be modulated according to a triangle pattern. For example, the spacing of the sequential bonds 300-308 can be monotonically increasing in uniform steps from the lowest spacing value to a highest value until the highest value is reached. Then, the spacing of the sequential bonds 300-308 can be monotonically decreasing in uniform steps until the lowest value is reached, whereupon the spacing cycle begins again.

In various embodiments, the spacing of the bonds 16 between a pair of subunits 14 is varied such that the longitudinal offset B between the intermittent bonds 16 of adjacent pairs of subunits 14 is approximately equal (e.g., a base longitudinal offset plus or minus 5% of the base longitudinal offset value).

In some embodiments, the spacing of sequential bonds in the ribbon 10 (e.g., the bonds 300-308) can be randomly variable within a specified range of values. In still other embodiments, the spacing of sequential bonds in the ribbon 10 can be randomly variable among a predefined set of values.

In some embodiments, the spacing of sequential bonds in the ribbon 10 can be increased or decreased in a non-random, non-step fashion. By way of example, and not limitation, a spacing between a sequential series of bonds can be varied by a linearly increasing value, a quadratically increasing value, or other changing rate of change. In other words, whereas a pattern of varying the spacing of sequential bonds between a pair of subunits 14 may be employed, such pattern need not change in uniform steps.

It is to be appreciated that in some embodiments, the longitudinal offset B between intermittent bonds 16 of adjacent pairs of subunits 14 may itself be variable due to the variability of the bond spacing A between each pair of subunits 14. For instance, if the spacing A between bonds 16 of each pair of subunits is random, the longitudinal offset B will necessarily be variable.

In order to facilitate manufacturing, a spacing of the bonds 16 along the length of a subunit may be variable between groups of bonds. For instance, a first grouping of sequential bonds between a pair of subunits can exhibit a same first spacing, a second grouping of sequential bonds between the pair of subunits can exhibit a same second spacing that is different than the first spacing, a third grouping of sequential bonds between the pair of subunits can exhibit a same third spacing, and so on.

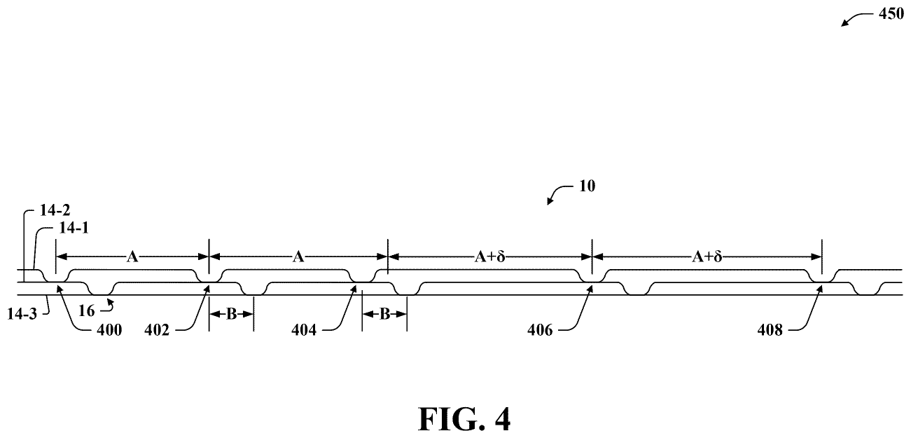

By way of further example, and referring now to FIG. 4, a schematic diagram 450 of another exemplary intermittent bond pattern is illustrated. In the bond pattern illustrated in the schematic diagram 450, the intermittent bonds 16 have a spacing that is variable but that does not necessarily vary from one bond 16 to the next for each and every bond 16. Stated differently, the bonds 16 can have a same spacing across several adjacent bonds, and then a different spacing at a next bond in the sequence of bonds 16. By way of further illustration, the ribbon 10 can include sequential bonds 400-408 between subunits 14-1 and 14-2. A first pair of adjacent bonds 400, 402 has a first spacing A. A second pair of adjacent bonds 402, 404 that immediately follows the first pair of adjacent bonds 400, 402 can have the same first spacing A. However, a third pair of adjacent bonds 404, 406 that immediately follows the second pair of adjacent bonds 402, 404 can have a second spacing A+δ. Then, a fourth pair of adjacent bonds 406, 408 that immediately follows the third pair of adjacent bonds 404, 406 can have the same second spacing A+δ.

In such embodiments, in order to maintain a desired spacing B of bonds between adjacent pairs of subunits, each pair of subunits can exhibit a same bond grouping pattern. In an example, the subunits 14-1 and 14-2 can have a first plurality of n bonds having a same first spacing, and a second plurality of n bonds having a same second spacing different than the first spacing. In such example, the adjacent pair of subunits 14-2 and 14-3 can likewise have a first plurality of n bonds having the same first spacing and a second plurality of n bonds having the same second spacing different than the first spacing. In these embodiments, the bonds joining the subunits 14-1 and 14-2 can maintain the bond spacing B vis-à-vis the bonds joining the subunits 14-2 and 14-3. However, it is to be appreciated that in some embodiments, different pairs of subunits 14 can have different bond patterns if maintaining a common bond spacing B between subunit pairs is not desired.

In various embodiments, the spacing between sequential bonds in the optical fiber ribbon 10 can be configured such that, over a given length of the ribbon 10, a desired mean spacing is achieved, otherwise referred to herein as zero-mean-variation. In a non-limiting example, the optical fiber ribbon 10 can be configured such that over any length of 5 meters of the optical fiber ribbon 10, the mean spacing over any series of sequential bonds is about 70 mm. More generally, the optical fiber ribbon 10 can be configured such that over any length of 5 meters of the optical fiber ribbon 10, the mean spacing the bonds 16 is within 5% of a mean value of the spacing of the bonds 16 across the entire ribbon 10. In a more particular embodiment, the mean spacing of the bonds 16 over any 5-meter length of the ribbon 10 can be within 2.5% of the mean value of the spacing of the bonds 16 across the entire ribbon 10. In a still more particular embodiment, the mean spacing of the bonds 16 over any 5-meter length of the ribbon 10 can be within 1% of the mean value of the spacing of the bonds 16 across the entire ribbon 10.

From the foregoing it is to be appreciated that “A” values of the bonds 16 in the optical fiber ribbon 10 may be characterized by a multimodal distribution, with modal peaks at or near each of multiple bond spacing values (e.g., a nominal target A, A+δ, A+2δ, and so on). In various embodiments, “A” values of the bonds 16 are characterized by a multimodal distribution in which at least one modal peak of the multimodal distribution is separated from another modal peak of the multimodal distribution by at least 300 microns. In more particular embodiments, the “A” values of the bonds 16 are characterized by a multimodal distribution having a separation of at least 500 microns between two peaks of the multimodal distribution. In still more particular embodiments, the “A” values of the bonds 16 are characterized by a multimodal distribution having a separation of at least 750 microns between two peaks of the multimodal distribution.

It will be appreciated by those of skill in the art that the nature of a “peak” of a multimodal distribution will vary depending upon the particular distribution in question, and that a peak of a multimodal distribution may be determined by any of various peak detection algorithms commonly employed in statistical analysis. In a non-limiting example, a “peak” of a multimodal distribution of the spacings of the bonds 16 (i.e., the “A” values) can be taken as a bin of spacing values that is a local maximum bin among a region bounded by nearest local minimum bins to the local maximum bin that each have a frequency that is 50% or less of a frequency of the local maximum bin, and wherein each bin of spacing values has a bin width of 20 microns. However, the multimodal embodiments referenced in the preceding paragraphs are not so-limited. For the purposes of evaluating the separation of modal peaks of a distribution, a peak can be said to be located at a center value of its corresponding bin.

In general, the “A” values of the bonds 16 in the optical fiber ribbon 10 are characterized by a variability that is outside a normal manufacturing variability of a process used to form the ribbon 10. In exemplary embodiments, peaks of a multimodal distribution of the “A” values for a given pair of optical fiber subunits 14 (whether such peaks are defined as in the immediately preceding paragraph or otherwise) can be separated by a distance that is greater than or equal to two standard deviations of a distribution that results from employing the same manufacturing process as the optical fiber ribbon 10 but without varying the “A” spacing of the bonds. In various embodiments, the “A” spacing between at least two pairs of bonds 16 joining a same pair of subunits 14 can differ by at least 300 microns. In more particular embodiments, the “A” spacing between at least two pairs of bonds 16 joining a same pair of subunits 14 can differ by at least 500 microns. In a still more particular embodiment, the “A’ spacing between at least to pairs of bonds 16 joining a same pair of subunits can differ by at least 750 microns.

In another exemplary configuration of the bonds 16, the bonds 16 joining a same pair of subunits 14 make up a first plurality of the bonds 16. This first plurality of the bonds 16 can be arranged such that at least 50% of “A” spacing values of the first plurality of bonds differ from a first “A” spacing value of the first plurality of bonds by at least 300 microns. Stated differently, if a first pair of bonds in the first plurality of bonds has an “A” spacing x, then at least 50% of the remaining “A” spacings of the first plurality of bonds will have spacings y that satisfy:

$$y \leq x - 300 μ or$$

$$y \geq x + 300 μ$$

It is to be appreciated that in the embodiment described above, the separation between the x value and the y values may instead be at least 500 microns, or in more particular embodiments at least 750 microns.

Optical fiber ribbons constructed according to various embodiments described herein have been constructed and exhibit less evidence of MPI-related attenuation than optical fiber ribbons having uniform spacing of the bonds 16 between a pair of subunits 14.

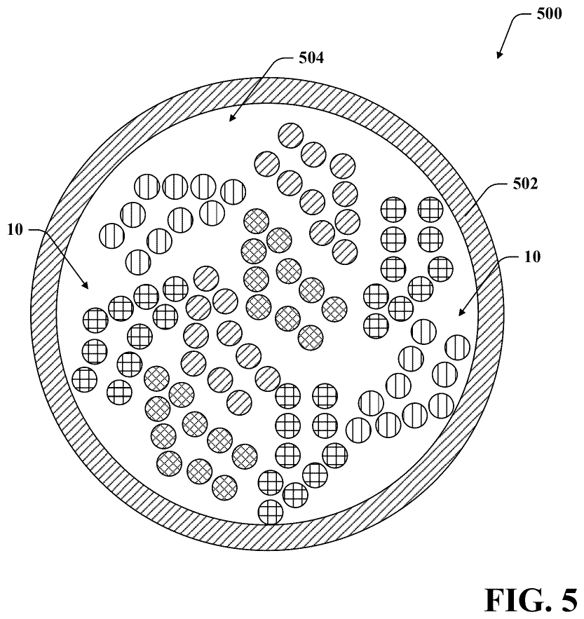

FIG. 5 is a cross-sectional diagram of an exemplary optical fiber cable 500 that incorporates optical fiber ribbons 10 having a variable spacing of the bonds 16 between a pair of subunits 14. The optical fiber cable 500 comprises a cable jacket 502 that surrounds a plurality of optical fiber ribbons 10 having the variable spacing of the bonds 16, as described above in various embodiments. The cable jacket 502 defines an interior cavity 504 in which a plurality of the optical fiber ribbons 10 are disposed. It is to be appreciated that the exemplary optical fiber cable 500 can include any of various additional features not depicted in FIG. 5 such as, but not limited to, water blocking elements (e.g., tapes, yarns, water blocking powder, etc.), access features (e.g., ripcords included within the interior cavity 504, coextruded strips of dissimilar polymer embedded in the cable jacket 502, etc.), binders (e.g., thin polymer films or binder yarns) for binding groups of the ribbons 10 together for organization and identification, or the like.

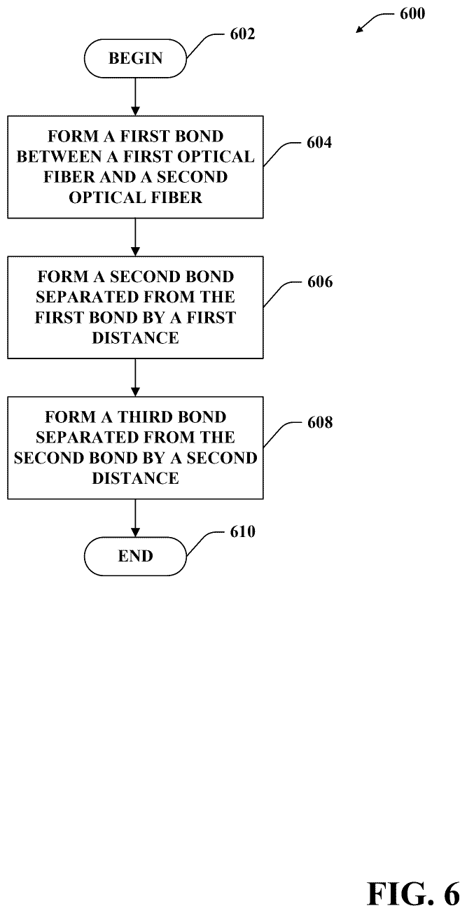

FIG. 6 illustrates an exemplary methodology 600 relating to forming intermittently-bonded optical fiber ribbons having variable spacing of bonds between a pair of subunits. While the methodology is shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement a methodology described herein.

The methodology 600 begins at 602 and at 604 a first bond is formed between a first optical fiber and a second optical fiber. In various embodiments, the first optical fiber and the second optical fiber can be optical fibers included in respective subunits, which subunits can further include one or more additional optical fibers. The first bond is formed along less than an entire length of the first and second optical fibers.

At 606 a second bond is formed between the first and second optical fibers, wherein the second bond is separated from the first bond by a first distance. Hence, the first and second optical fibers are intermittently bonded by the first and second bonds. At 608, a third bond between the first and second optical fibers is formed, wherein the third bond is separated from the second bond by a second distance that is different from the first distance (e.g., outside an ordinary manufacturing variability of the first spacing between the first and second bonds). The first, second, and third bonds can be sequential bonds such that the first and second bonds are adjacent, and the second and third bonds are adjacent. In other words, the first, second, and third bonds are formed such that a spacing between adjacent bonds that join a same pair of fibers (or subunits) is variable. It is to be appreciated that the variable spacing of bonds formed according to the methodology 600 can vary according to any of various bond spacing schemes for mitigating MPI described above.

It is further to be appreciated that forming the second bond 606 and forming the third bond 608 can involve the acts of controlling equipment used to form the second and third bonds in order to target the different first and second distances by which the pairs of bonds (i.e., first bond-second bond/second bond-third bond) are to be separated. Stated differently, one or more of the acts 606, 608 can involve the further acts of controlling manufacturing equipment, such as a deposition device, to target different spacings between different pairs of bonds when depositing either or both of the second and third bonds. By way of example, and not limitation, a line speed of a manufacturing line that advances an optical fiber ribbon through a deposition device can be set to a first line speed to target a first spacing between a first pair of bonds and set to a second line speed to target a second spacing between a second pair of bonds. In a further non-limiting example, a set point for a time delay between emissions of a bond material by a deposition device can be varied to target different first and second bond spacings. In a still further example, a set point for a spacing between deposition orifices of a deposition device can be varied to target different first and second bond spacings. In yet another example, a set point of a measured distance of a next deposition location from an observed bond (e.g., as measured by a vision system) can be varied to target different first and second bond spacings. In these and other embodiments, updating of the set point can be done between acts 606, 608, such that the set point is updated after forming the second bond 606 and prior to forming the third bond 608, thus yielding a different spacing between the first bond/second bond pair and the second bond/third bond pair. The methodology 600 ends at 610.

What has been described above includes examples of one or more embodiments. It is, of course, not possible to describe every conceivable modification or alteration of the above systems, devices, or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flexible optical fiber ribbon, comprising:
a first optical fiber;
a second optical fiber; and
a plurality of bonds that join the first optical fiber and the second optical fiber, the plurality of bonds spaced along the lengths of the first optical fiber and the second optical fiber, the plurality of bonds comprising:
a first bond;
a second bond being a next bond after the first bond along the lengths of the first and second optical fibers; and
a third bond being a next bond after the second bond along the lengths of the first and second optical fibers, wherein the first bond and the second bond are separated by a first distance and the second bond and the third bond are separated by a second distance that is greater than or less than the first distance.

2. The flexible optical fiber ribbon of claim 1, wherein the second distance is about 0.5 millimeters greater than the first distance.

3. The flexible optical fiber ribbon of claim 2, wherein the first distance is about 70 mm and the second distance is about 70.5 mm.

4. The flexible optical fiber ribbon of claim 1, wherein the plurality of bonds are spaced such that a mean spacing of adjacent bonds in the plurality of bonds over any span of 5 meters along a length of the flexible optical fiber ribbon is within 5% of a mean spacing of adjacent bonds in the plurality of bonds over the entire length of the flexible optical fiber ribbon.

5. The flexible optical fiber ribbon of claim 1, wherein the plurality of bonds are spaced such that a mean spacing of adjacent bonds in the plurality of bonds over any span of 5 meters along a length of the flexible optical fiber ribbon is within 2.5% of a mean spacing of adjacent bonds in the plurality of bonds over the entire length of the flexible optical fiber ribbon.

6. The flexible optical fiber ribbon of claim 1, wherein the plurality of bonds are spaced such that a mean spacing of adjacent bonds in the plurality of bonds over any span of 5 meters along a length of the flexible optical fiber ribbon is within 5% of a mean spacing of adjacent bonds in the plurality of bonds over the entire length of the flexible optical fiber ribbon.

7. The flexible optical fiber ribbon of claim 1, wherein the plurality of bonds are characterized by a zero mean variation of a spacing of the bonds over any span of 5 meters along a length of the flexible optical fiber ribbon.

8. The flexible optical fiber ribbon of claim 1, wherein spacings of the plurality of bonds that join the first optical fiber and the second optical fiber are characterized by a multimodal distribution.

9. The flexible optical fiber ribbon of claim 8, wherein the multimodal distribution includes a first peak and a second peak, wherein the first peak and the second peak are separated by a distance of at least 750 microns.

10. The flexible optical fiber ribbon of claim 9, wherein the first peak is a local maximum of the multimodal distribution in a region bounded by nearest local minima of the multimodal distribution that each have a frequency that is 50% or less of a frequency of the local maximum.

11. The flexible optical fiber ribbon of claim 10, wherein the local maximum of a local maximum bin of spacing values, and the local minima are local minimum bins of spacing values, wherein a size of the local maximum bin and the local minimum bins is 20 microns.

12. The flexible optical fiber ribbon of claim 8, wherein the multimodal distribution includes a first peak and a second peak, wherein the first peak and the second peak are separated by a distance of at least 500 microns.

13. The flexible optical fiber ribbon of claim 8, wherein the multimodal distribution includes a first peak and a second peak, wherein the first peak and the second peak are separated by a distance of at least 300 microns.

14. An optical fiber cable, comprising:
a cable jacket having an interior surface and an exterior surface, the exterior surface being an outermost surface of the optical fiber cable, the interior surface defining a central bore;
a flexible optical fiber ribbon disposed within the central bore, the flexible optical fiber comprising:
a first optical fiber; and
a second optical fiber, wherein the first optical fiber and the second optical fiber are connected by a plurality of intermittent bonds, and wherein the intermittent bonds have a variable spacing.

15. The optical fiber cable of claim 14, wherein the variable spacing of the intermittent bonds is characterized by a multimodal distribution having a plurality of peaks.

16. A method of manufacturing a flexible optical fiber ribbon, comprising:
forming a first bond between a first optical fiber and a second optical fiber;
forming a second bond between the first optical fiber and the second optical fiber, the first bond and the second bond separated by a first spacing;
forming a third bond between the first optical fiber and the second optical fiber, the second bond and the third bond separated by a second spacing.

17. The method of claim 16, wherein forming the third bond comprises:
updating a set point of a deposition device to target a different spacing between:
a) a first pair of bonds consisting of the first bond and the second bond; and
b) a second pair of bonds consisting of the second bond and the third bond; and
forming the third bond based upon the updated set point.

18. The method of claim 16, further comprising:
changing a line speed of a manufacturing line used to form the flexible optical fiber ribbon subsequent to forming the second bond and prior to forming the third bond such that the second spacing is different from the first spacing.

19. The method of claim 16, wherein forming the second bond is based upon a time delay set point that defines a first time delay between forming the first bond and forming the second bond, the method further comprising:
changing the time delay set point to define a second time delay between forming the second bond and forming the third bond, such that the second bond and the third bond are separated by the second spacing that is different from the first spacing.

20. The method of claim 16, wherein forming the second bond is based upon a measured bond distance set point that defines the first spacing, the method further comprising:
changing the measured bond distance set point to define the second spacing, wherein forming the third bond is based upon the measured bond distance set point defining the second spacing.
